(19) United States
(12) Patent Application Publication
(10) Pub. No.: US 2025/0242429 A1
(43) Pub. Date: Jul. 31, 2025

(54) WELDING TOOL HAVING A CURVED AND STRUCTURED WORKING SURFACE, METHOD FOR WELDING AND WELDED WORKPIECE

(71) Applicant: Telsonic Holding AG, Bronschhofen (CH)

(72) Inventor: Shimaalsadat MOSTAFAVI, Winterthur (CH)

(73) Assignee: Telsonic Holding AG, Bronschhofen (CH)

(21) Appl. No.: 18/855,792

(22) PCT Filed: Apr. 5, 2023
(86) PCT No.: PCT/EP2023/058986

§ 371 Date: Oct. 10, 2024

(30) Foreign Application Priority Data
Apr. 13, 2022 (EP) 22168207.3

(51) Int. Cl. B23K 20/10; B23K 101/36; B23K 103/10; B23K 103/12

(52) U.S. Cl. CPC B23K 20/106; B23K 2101/36; B23K 2103/10; B23K 2103/12

(57) ABSTRACT

Disclosed is a tool (10) for welding a workpiece (21) by means of friction welding, in particular by means of ultrasound, wherein the tool (10) has a working surface (5) which contains at least one, preferably several, grooves (6). The working surface (5) has a curvature. The invention also relates to a method for welding a workpiece and a welded workpiece.

This application is a National Stage completion of PCT/EP2023/058986 filed Apr. 5, 2023, which claims priority from European patent application serial no. 22168207.3 filed Apr. 13, 2022.

### FIELD OF THE INVENTION

The present invention relates to tools, in particular sonotrodes, for welding workpieces by means of friction welding, to methods for welding a workpiece using such a workpiece and to welded workpieces.

### BACKGROUND OF THE INVENTION

A typical application of such sonotrodes is the welding of battery cell components. The known sonotrodes have welding surfaces that are usually equipped with knurling. This often results in the formation of unwanted metal particles (so-called whiskers), which can lead to short circuits, for example. Another application is the welding of contact points on IGBT modules (IGBT: insulated-gate bipolar transistors). Metal particles can also cause damage there.

### SUMMARY OF THE INVENTION

It is an object of the present invention to overcome the disadvantages mentioned. In particular, the formation of interfering metal particles should therefore be prevented as far as possible during friction welding and, in particular, ultrasonic welding of metals. The same problem should also be overcome in the friction welding of plastics, in particular metallized or carbon fibre-reinforced plastics.

According to a first aspect of the invention, this object is solved by a tool for welding a workpiece by means of friction welding, in particular by means of ultrasound. The tool may be a sonotrode or an anvil. The tool has a working surface, in particular a welding surface. The working surface contains at least one groove. According to the invention, the working surface has a curvature.

As has been shown in test series, such a geometry of the working surface causes a considerable reduction of unbound metal particles or carbon particles. Without limiting the invention to this, it is currently assumed that the material flow of the workpiece that occurs during welding is specifically guided in the direction of the grooves. The curvature of the working surface has the effect that initially only a part of the working surface comes into contact with the workpiece, so that the pressure on the workpiece is increased locally. This leads to plastic deformation and a flow of material. The grooves guide the softened material of the workpiece away from the welding point and form strands of material that cannot be easily detached during and after welding. Metal particles or carbon particles are bound into these strands of material and can no longer detach. Nevertheless, the process according to the invention can be used to produce welded joints that can withstand high pull-out forces.

The sonotrode can have a longitudinal axis with respect to which the sonotrode can be excited to torsional ultrasonic vibrations. The working surface can be aligned essentially perpendicular to the longitudinal axis. Furthermore, the at least one groove can extend essentially in a radial direction with respect to the longitudinal axis. Alternatively, the sonotrode can also be a sonotrode that can be excited to vibrate linearly, whereby the welding surface vibrates along a surface of the workpiece when used as intended. In this case, the grooves can run parallel or transverse to the direction of vibration.

In a currently preferred embodiment, the working surface has a convex curvature at least in sections. In particular, the entire working surface can have a convex curvature. This has the effect, that during welding, a central section of the working surface initially comes into contact with the workpiece and the material of the workpiece is guided radially outwards along the grooves. It is preferable if the at least one groove extends to the center of the work surface.

Alternatively, it is also possible for the work surface to have a concave curvature, at least in sections. In particular, the entire work surface can have a concave curvature. In this variant, an outer area of the work surface initially comes into contact with the workpiece, and the grooves ensure a radial flow of material inwards. For this purpose, it is preferable if the at least one groove extends to the outer circumference of the working surface, in particular in a radial direction.

The working surface can have a curvature height in the range of 0.1 mm to 0.3 mm. This refers to the height of the curvature in a projection along the longitudinal axis.

Alternatively or additionally, the working surface can have a radius of curvature in the range from 0.5 mm to 20 mm. In particular, the radius of curvature can be in the range of 6 mm to 12 mm in the case of a convex curvature and in the range of 12 mm to 20 mm in the case of a concave curvature. The radius of curvature can also be equal to half the diameter of the working surface; the working surface is then hemispherical.

The at least one groove can have a depth in the range from 0.2 mm to 0.5 mm, at least in sections. In particular, the depth of the groove can be in the range from 0.3 mm to 0.4 mm in the case of a convex curvature of the working surface, and in the range from 0.4 mm to 0.5 mm in the case of a concave curvature of the working surface.

The at least one groove can have a width in the range from 0.4 mm to 0.6 mm, at least in sections. In particular, the width of the groove can be in the range from 0.4 mm to 0.5 mm in the case of a convex curvature of the working surface and in the range from 0.45 mm to 0.55 mm in the case of a concave curvature of the working surface.

The at least one groove can have a flank angle that can be in the range from 15° to 75°, preferably in the range from 30° to 60°.

In the area of at least one of its ends, in particular in a center point and/or on an outer circumference of the welding surface, the depth and/or the width of the groove can be smaller than in its central area.

The groove can be cut into the work surface with a milling cutter, for example, and taper towards the end.

The working surface can, for example, have 8 to 12, in particular 10 to 12 grooves. The grooves are preferably evenly distributed in the circumferential direction over the entire circumference. Tests have shown that the effect of material flow is less in the case of a convex curvature than in the case of a concave curvature. Therefore, a larger number of grooves might be recommendable in the case of a convex curvature.

The working surface can have a diameter measured perpendicular to the longitudinal axis in the range from 1 mm to 8 mm, preferably from 1.5 mm to 6 mm.

It is also conceivable to design an anvil with a curvature and grooves to bind particles present on the sides of an anvil.

The tool, in particular the sonotrode, can be made of steel, titanium or a hard metal, for example.

A further aspect of the invention relates to a method for welding a workpiece by means of ultrasound using a tool with a curved working surface provided with grooves, but also with workpieces having a 3-dimensional surface with structural features which allow the softened material to flow. The method is carried out in particular using a tool as described above, in particular a sonotrode as described above. The method includes a step in which the working surface of the tool is brought into contact with the workpiece and the tool, in particular the sonotrode, is excited to vibrate so that the workpiece is welded, in particular welded to a further, second workpiece. According to the process, the material of the workpiece is softened during welding and displaced along the grooves or along the structural features on the surface of the workpiece. As a result of this material flow, potential particles are incorporated into an accumulation of material, in particular in a strand, which is formed by the passage of the melted material along the groove or by a movement along the structural features.

The advantages described above result from the implementation of this procedure.

The workpiece can be made of a metal such as aluminum. In particular, it can be aluminum of type H14. It has been shown that even better results can be achieved with this type of aluminum compared to other types of aluminum due to the material properties and in particular the flow properties. Alternatively, the metal can also be copper, for example. In order to increase the effect of material flow, softer copper with a rather low yield strength can be used. In yet another variant, the workpiece can also consist of a plastic, in particular a plastic provided with metal or carbon particles.

In some applications, the workpiece is a connection contact and the second workpiece is a battery container to which the connection contact is to be welded. Alternatively, the second workpiece can be a capacitor or a semiconductor element, such as an IGBT (insulated-gate bipolar transistor).

In a third aspect, the invention also relates to a workpiece composed of several parts by welding, which is obtained or obtainable by a method described above. The welded workpiece thus has a welding area whose geometry corresponds to that of the working surface of the tool. In particular, the composite workpiece and, in particular, the welded joint therefore contains accumulations of material in which metal particles (in particular whiskers) or other particles are incorporated. The material accumulations are in particular ribs that preferably extend in a radial direction. As already explained, such a workpiece welded according to the invention contains significantly fewer unbound particles, in particular metal particles, on the surface.

The workpiece can be made of a metal such as aluminum, especially type H14 aluminum, or copper.

### BRIEF DESCRIPTION OF THE DRAWINGS

The invention is explained in more detail below with reference to two embodiments and drawings. They show:

FIG. 1: A perspective view of a first sonotrode according to the invention;

FIG. 2a: A detailed perspective view of a welding surface of the first sonotrode according to the invention;

FIG. 2b: A detailed side view of the welding surface of the first sonotrode according to the invention;

FIG. 2c: Plan view of the welding surface of the first sonotrode according to the invention;

FIG. 3a: A detailed perspective view of a welding surface of a second sonotrode according to the invention;

FIG. 3b: A detailed side view of the welding surface of the second sonotrode according to the invention;

FIG. 3c: Plan view of the welding surface of the second sonotrode according to the invention;

FIG. 4: An illustration of a welded joint produced with a sonotrode not according to the invention;

FIG. 5a: An illustration of a welded joint produced with the first sonotrode according to the invention;

FIG. 5b: An illustration of a welded joint produced with the second sonotrode according to the invention;

FIG. 6: A detailed perspective view of a welding surface of a third sonotrode according to the invention;

FIG. 7: A detailed perspective view of a welding surface of a fourth sonotrode according to the invention;

FIG. 8: A welding surface of a fifth sonotrode according to the invention in a perspective detail view;

FIG. 9: A detailed perspective view of a welding surface of a sixth sonotrode according to the invention.

### DETAILED DESCRIPTION OF THE PREFERRED EMBODIMENTS

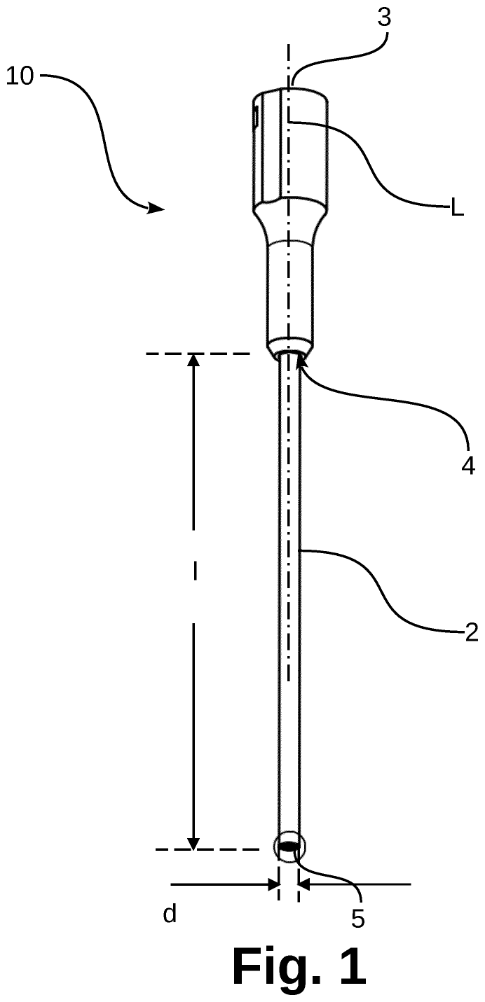

FIG. 1 shows a first sonotrode 10 according to the invention. It has a base body 1 with a coupling surface 3 for coupling ultrasonic vibrations and a processing pin 2 extending along a longitudinal axis L with a welding surface 5 for emitting the ultrasonic vibrations to a workpiece not shown here. The welding surface 5 is arranged on an end face of the processing pin 2 opposite the base body 1. The processing pin 2 is connected to the base body 1 by pressing it into a press-fit opening 4 formed in the base body 1. Alternatively, the connection could be created by laser welding, for example.

The processing pin 2 has an overall circular cylindrical shape. It can have a diameter d in the range from 1.5 mm to 6 mm, for example. If the processing pin 2 is made of steel, for example, it can have a length l of 80 mm or 160 mm, which corresponds to a half or full wavelength at a resonance frequency of 20 kHz. If, on the other hand, the processing pin 2 is made of a hard metal such as tungsten carbide, the half wavelength at the frequency mentioned is approximately 130 mm. In the example shown here, the base body 1 is made of titanium and has a length that corresponds to half the wavelength in this material in this example.

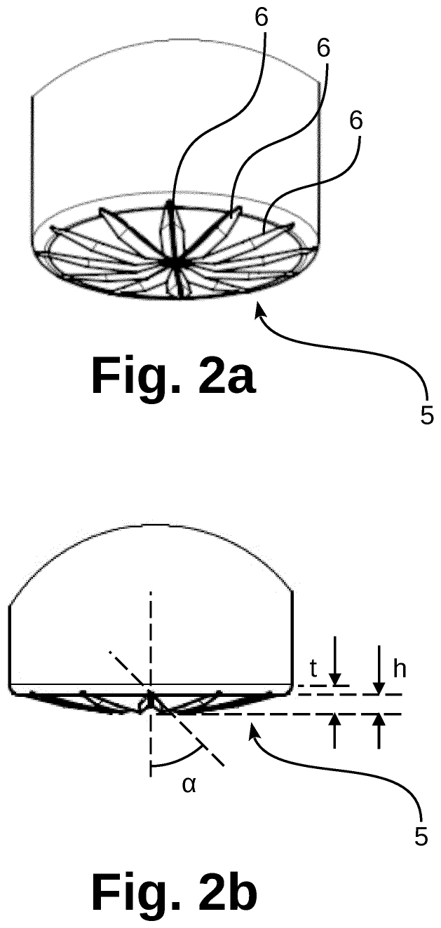

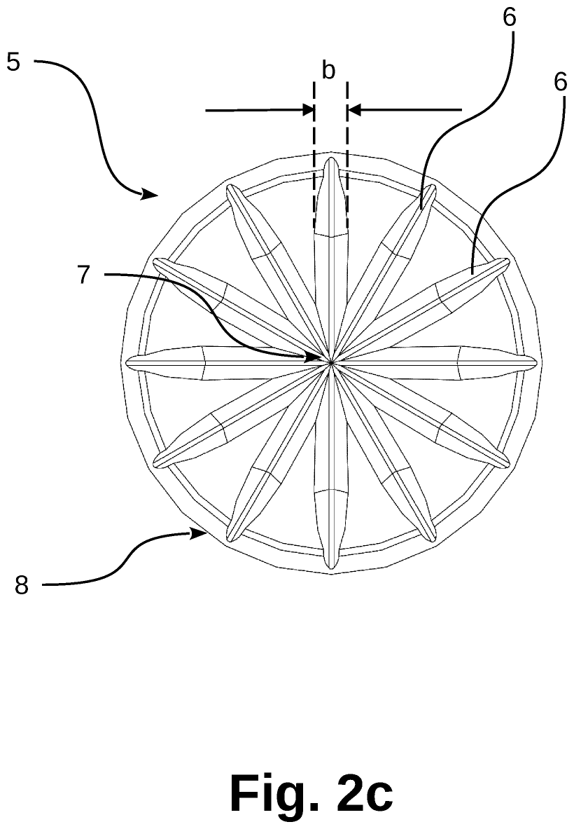

FIGS. 2a to 2c show the welding surface 5 in detail. The entire welding surface 5 has a convex curvature with a curvature radius of 9 mm and a curvature height h of 0.2 mm. In the welding surface 5, 12 grooves 6 are formed which are evenly distributed in the circumferential direction over the entire circumference and which extend in the radial direction, namely from a center point 7 to the outer circumference 8 of the welding surface 5. The grooves 6 have a depth t of 0.36 mm at the center point 7 and have a width of 0.45 mm and run out towards the outer circumference 8. They have a flank angle α, which is 45° in this example.

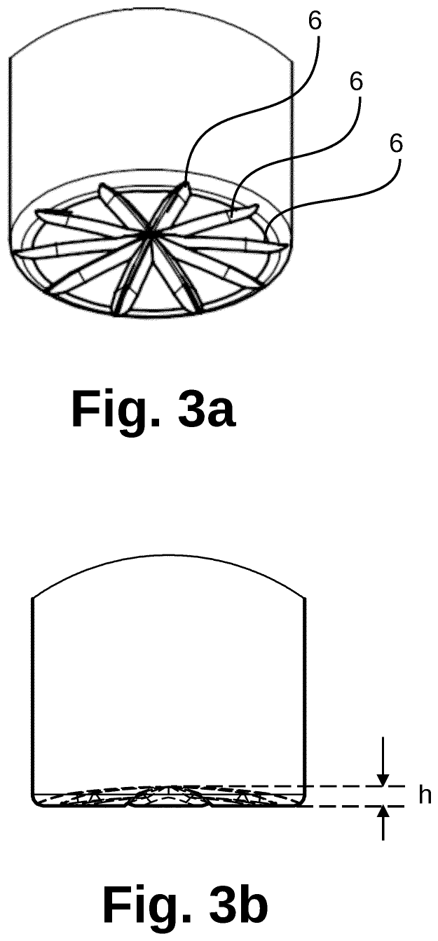

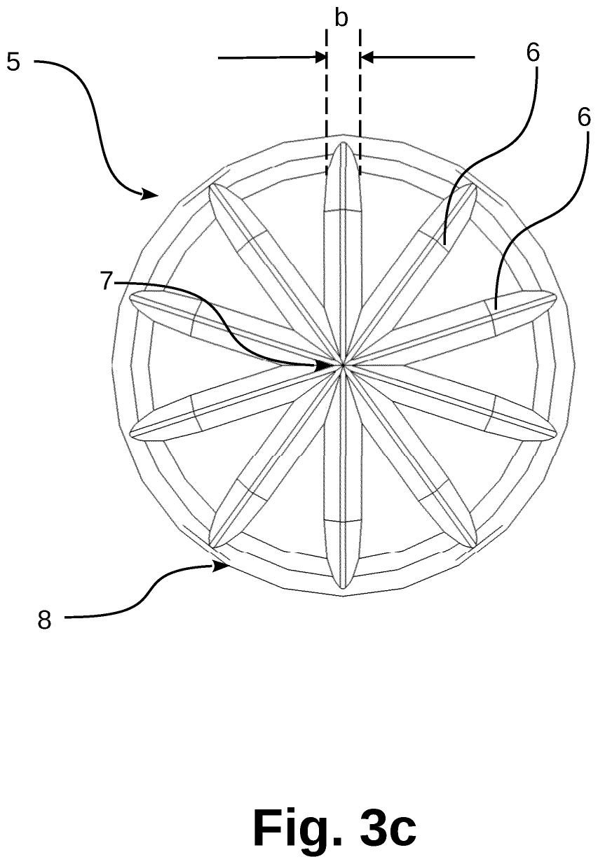

FIGS. 3a to 3c show a second embodiment in which, however, the welding surface 5 is concave and contains only 10 grooves 6. The grooves 6 have a depth of 0.42 mm and a width of 0.49 mm on the outer circumference 8 and taper towards the center 7.

In contrast to the embodiments described above, the sonotrode can of course also be designed as a single piece.

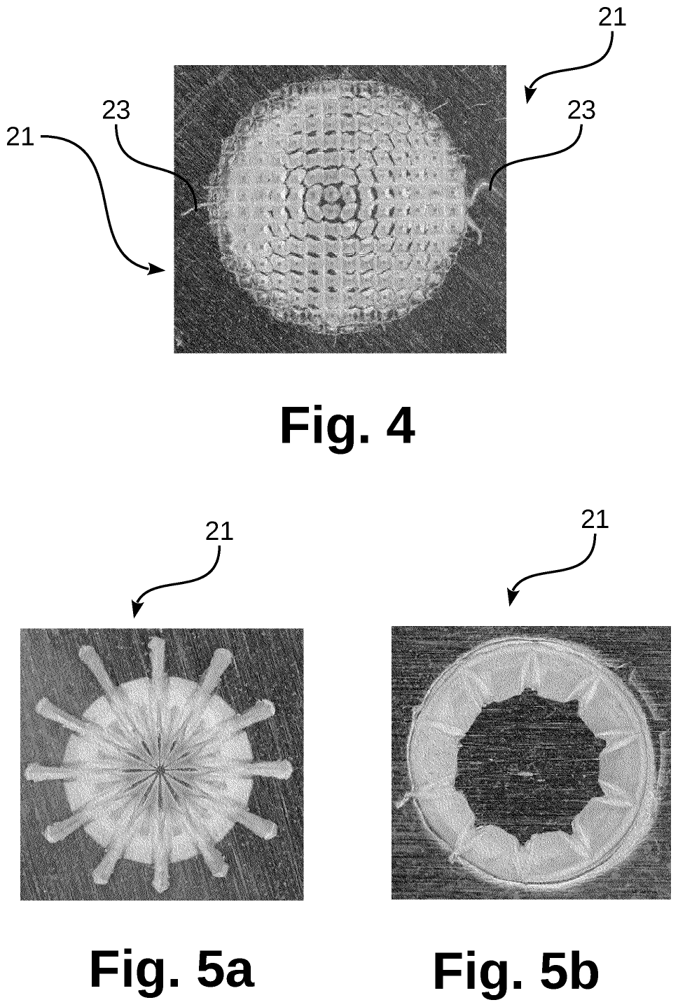

FIGS. 4 to 5a show sections of welded workpieces 21 that have been welded with sonotrodes not according to the invention or according to the invention.

FIG. 4 shows a weld that was welded with a conventional sonotrode, which has an essentially flat welding surface with knurling. Several unwanted metal particles 23 (“whiskers”) can be seen at the edge of the weld, which can lead to quality problems.

The welding point shown in FIG. 5a was produced with the first sonotrode according to the invention as shown in FIGS. 2a to 2c. The image clearly shows that the sonotrode was only in contact with the workpiece 21 in a central area due to its convex curvature. The grooves of the sonotrode have formed a flow of material created during welding radially outwards to form thicker strands of material, which cannot be easily detached even after welding and in which metal particles are embedded.

The weld shown in FIG. 5b was produced with the second sonotrode according to the invention as shown in FIGS. 3a to 3c. As can be seen from the photo, the sonotrode was only in contact with the workpiece 21 in its outer area due to the concave curvature of the welding surface.

A sonotrode with a convex welding surface was used to perform welds with the input parameters amplitude, energy and pressure listed below. At least 10 tests resulted in welding times in the range of 220 ms to 240 ms and peak powers in the range of 240 W to 280 W, with a “whisker” occurring in only one case. The welds withstood pull-off forces ranging from 10 N to over 140 N.

If the workpieces were cleaned before welding, there were also no or only a few “whiskers” in 10 tests, but the welds consistently withstood pull-off forces of more than approx. 60 N.

A sonotrode with a concave welding surface was used to perform welds with the input parameters amplitude, energy and pressure listed below. Welding times in the range of 90 ms to 100 ms and peak powers in the range of 450 W to 550 W were obtained, with a maximum of three “whiskers” occurring in 10 tests. The welds withstood pull-off forces in the range from around 50 N to around 190 N.

When the workpieces were cleaned before welding, the welds consistently withstood pull-off forces of more than 140 N.

The following combination of parameters has proven to be particularly favorable for welding with a convex welding surface:
Amplitude: 90% of the maximum amplitude achievable with the sonotrode, for example 15 μm to 50 μm;
Diameter: 1.5 mm to 6 mm (corresponding to an area of 1.77 mm² to 28.3 mm²)
Force: 100 N to 600 N;
Energy: 5 Ws to 500 Ws, in particular 20 Ws to 60 Ws, in particular 30 Ws to 50 Ws, for example 40 Ws;
Average time: 100 ms to 400 ms, in particular 200 ms to 300 ms, for example 230 ms.

The following combination of parameters has proven to be favorable for welding with a concave welding surface:
Amplitude: 75% of the maximum amplitude achievable with the sonotrode, for example 15 μm to 50 μm;
Diameter: 1.5 mm to 6 mm (corresponding to an area of 1.77 mm² to 28.3 mm²);
Force: 100 N to 600 N;
Energy: 5 Ws to 500 Ws, in particular 20 Ws to 60 Ws, in particular 30 Ws to 50 Ws, for example 40 Ws;
Average time: 100 ms to 400 ms, in particular 200 ms to 300 ms, for example 230 ms.

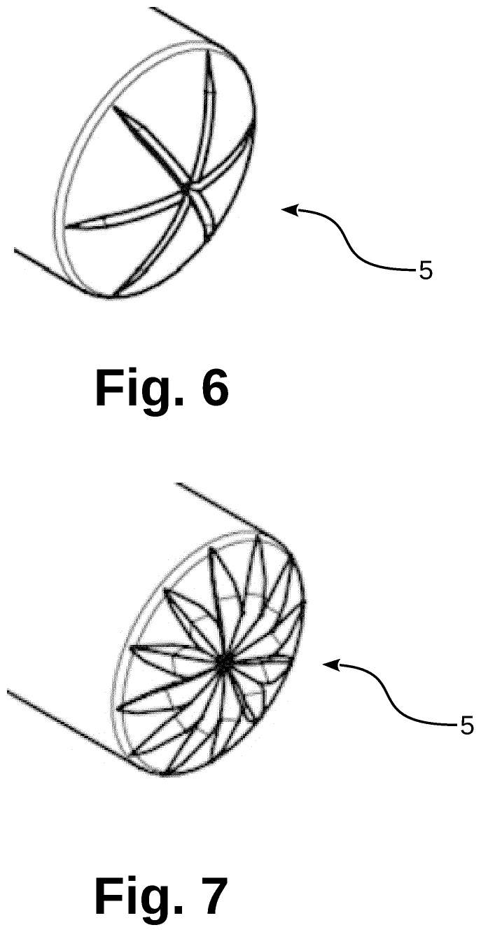

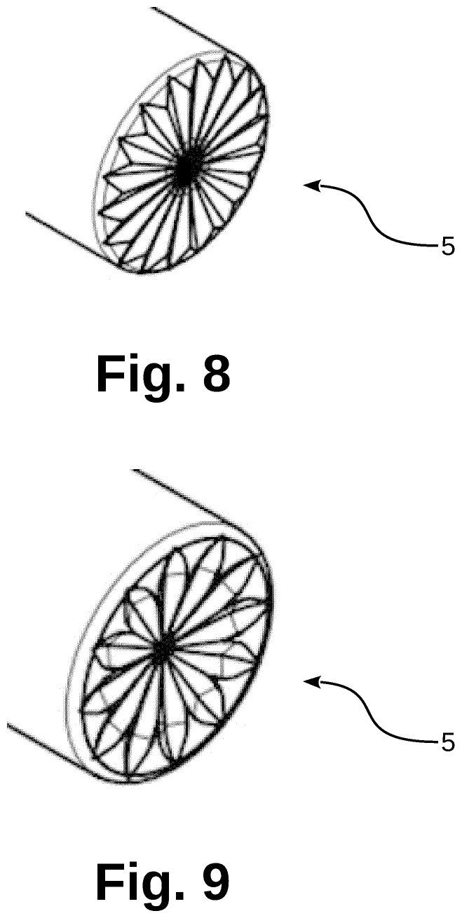

FIGS. 6 to 9 show working surfaces of further sonotrodes according to the invention, each of which has a diameter d=2.5 mm and working surfaces 5 with the following geometric parameters:

| | | | | Depth t of | |
|---|---|---|---|---|---|
| | | Radius of | | the grooves | Flank angle |
| | | curvature | Number of | at the center | α of the |
| Figure | Curvature | [mm] | grooves | [mm] | grooves [°] |
| 6 | convex | 2.0 | 6 | 0.10 | 30 |
| 7 | convex | 2.5 | 12 | 0.15 | 45 |
| 8 | convex | 3.0 | 18 | 0.20 | 60 |
| 9 | concave | 10.0 | 12 | 0.10 | 60 |

1-23. (canceled)

24. A tool for welding a workpiece by means of friction welding, in particular by means of ultrasound, the tool having a working surface which contains at least one, preferably a plurality of grooves, wherein the working surface has a curvature.

25. The tool according to claim 24, wherein the tool is a sonotrode for welding a workpiece and the working surface forms a welding surface.

26. The tool according to claim 25, wherein the sonotrode has a longitudinal axis and is configured to be excited to torsional ultrasonic vibrations with respect to said longitudinal axis.

27. The tool according to claim 26, wherein the at least one groove extends substantially in a radial direction with respect to the longitudinal axis.

28. The tool according to claim 24, wherein the working surface has a convex curvature at least in sections, in particular the entire working surface.

29. The tool according to claim 24, wherein the working surface has a concave curvature at least in sections, in particular the entire working surface.

30. The tool according to claim 24, wherein the at least one groove extends to a center of the working surface.

31. The tool according to claim 24, wherein the at least one groove extends to the outer circumference of the working surface.

32. The tool according to claim 24, wherein the working surface has 8 to 16, in particular 10 to 12 grooves, which are preferably evenly distributed in the circumferential direction.

33. The tool according to claim 24, wherein the working surface has a diameter measured in a direction perpendicular to a longitudinal axis of the tool in the range from 1 mm to 8 mm, preferably from 1.5 mm to 6 mm.

34. The tool according to claim 24, wherein the working surface has a height of curvature in the range from 0.1 mm to 0.3 mm.

35. The tool according to claim 24, wherein the working surface has a radius of curvature in the range from 0.5 mm to 20 mm.

36. The tool according to claim 24, wherein the at least one groove has a depth in the range from 0.2 mm to 0.5 mm, at least in sections.

37. The tool according to claim 24, wherein the at least one groove has a width in the range from 0.4 mm to 0.6 mm, at least in sections.

38. The tool according to claim 24, wherein the at least one groove has a flank angle which is in the range from 15° to 75°, preferably in the range from 30° to 60°.

39. The tool according to claim 25, wherein the sonotrode has a base body with a coupling surface for coupling ultrasonic vibrations and a processing pin extending along a longitudinal axis and having a welding surface.

40. The tool according to claim 39, wherein the processing pin has a diameter in the range from 1.5 mm to 6 mm.

41. A method for welding a workpiece, in particular by means of ultrasound, comprising the steps of
providing a tool and a workpiece, the tool having a curved working surface which is provided with grooves or the workpiece having a 3-dimensional surface with structural features,
bringing into contact a working surface of the tool with the workpiece,
exciting the tool to vibrate, so that the workpiece is welded, in particular welded to a further workpiece,
wherein the material of the workpiece is at least partially softened and displaced along the grooves of the working surface or along the structural features on the surface of the workpiece, so that particles are incorporated into an accumulation of material by the material flow, which is formed by the movement of the molten material along the groove or by a movement along the structural features.

42. The method according to claim 41, wherein the workpiece consists of a metal.

43. The method according to claim 42, wherein the workpiece consists of aluminum, in particular aluminum of type H14, or copper.

44. The method according to claim 41, wherein the workpiece is a terminal contact of a battery and the further workpiece is a receptacle of a battery.

45. A welded workpiece obtained or obtainable by a method according to claim 41.

46. The welded workpiece according to claim 45, wherein the workpiece consists of a metal such as aluminum, in particular aluminum of type H14, or copper.

47. A welded workpiece with a welding area, wherein the workpiece and in particular the welding area has material accumulations in which particles are incorporated, wherein the material accumulations are ribs which preferably extend in a radial direction.
